(19) United States
(12) Patent Application Publication
(10) Pub. No.: US 2008/0053516 A1
(43) Pub. Date: Mar. 6, 2008

(54) Solar cell modules comprising poly(allyl amine) and poly (vinyl amine)-primed polyester films

(76) Inventor: Richard Allen Hayes, Beaumont, TX (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/512,825

(22) Filed: Aug. 30, 2006

(51) Int. Cl. H02N 6/00

(52) U.S. Cl. 136/251

(57) ABSTRACT

The present invention provides a solar cell module comprising at least one layer of a poly(allyl amine) or poly(vinyl amine)-primed polyester film, and the process for making the solar cell module.

### FIELD OF THE INVENTION

The present invention relates to solar cell modules and laminates comprising at least one polyester film with at least one surface, coated with a coating of polyolefin having at least one primary amine functional group, preferably, poly(allyl amine) or poly(vinyl amine).

### BACKGROUND OF THE INVENTION

Photovoltaic (solar) cell modules are units that convert light energy into electrical energy. Typical or conventional construction of a solar cell module includes at least 5 structural layers. The layers of a conventional solar cell module are constructed in the following order starting from the top, or incident layer (that is, the layer first contacted by light) and continuing to the backing (the layer furthest removed from the incident layer): (1) incident layer, (2) front-sheet encapsulant layer, (3) voltage-generating layer (solar cell layer), (4) back-sheet (second) encapsulant layer, and (5) back-sheet (backing layer). The function of the incident layer is to provide a transparent protective window that will allow sunlight into the solar cell module. The incident layer is typically a glass plate or a thin polymeric film (such as a fluoropolymer or polyester film), but could conceivably be any material which is transparent to sunlight.

In the fabrication of laminated solar cell modules, it is customary to place a piece of encapsulant sheeting between the solar cell(s) and the other module layers, such as the incident layers and the back-sheets. The encapsulant layers are designed to encapsulate and protect the fragile solar cell layers. Generally, a solar cell module will incorporate at least two encapsulant layers sandwiched around the solar cell layer. The two encapsulant layers can be the same material or different and distinct. The optical properties of the front-sheet encapsulant layer must be such that light can be effectively transmitted to the solar cell layer.

Materials may be used in forming solar cell encapsulant layers include, for example, polyvinyl butyral (PVB); thermoplastic polyurethane (TPU); ethylene copolymers such as ethylene vinyl acetate (EVA); ethylene copolymers which incorporate acid functionality, such as poly(ethylene-co-(meth)acrylic acid), and ionomers formed therefrom; silicone polymers; and polyvinyl chloride (PVC).

As solar cell modules evolve, greater interlayer adhesion has been found desirable, especially for highly engineered solar cell modules which incorporate additional layers that may function to protect the solar cell from environmental damage and therefore prolong its useful life. Polyester films, especially bi-axially-oriented poly(ethylene terephthalate) films, have been increasingly used within solar cell module constructions. The polyester films may serve as the incident layers and/or the back-sheets in solar cell laminates. The polyester films may also serve as dielectric layers between the solar cell and a galvanized steel or aluminum foil back-sheet. Moreover, the polyester films may be used in solar cell laminates as barrier layers, e.g., sodium ion, oxygen or moisture barrier layers. If desired, the polyester film may be coated. For example, the coating may function as oxygen and moisture barrier coatings, such as the metal oxide coating disclosed in U.S. Pat. Nos. 6,521,825 and 6,818,819 and European Patent No. EP 1 182 710 and other coatings, such as disclosed in U.S. Pat. No. 6,414,236.

The adhesion of the polyester film to other solar cell layers has been recognized as a shortcoming within the art, even with common art polyester film surface treatments, such as surface flame, plasma or corona treatment and/or the use of primer adhesives, such as amino- or glycidoxy-functional silanes. Significant efforts have been made to overcome this shortcoming. For example, U.S. Pat. Nos. 5,728,230; 6,075,202 and 6,232,544 have disclosed a complicated five layer structure to improve the adhesion of a polyester sheet to be embedded within a solar cell module.

Recently, poly(ally amine) and poly(vinyl amine) materials have been considered as adhesive primers. For example, in U.S. Pat. Nos. 5,411,845; 5,690,994; 5,698,329 and 5,770,312, a coated film, such as a poly(ethylene terephthalate) film, which includes a subbing layer containing an allyl amine polymer was disclosed to have excellent adhesion to photographic emulsion layers. Composite structures, generally of a porous substrate, such as cloth, to a film, such as poly(ethylene terephthalate) film, which include an intermediate layer derived from an aqueous adhesive emulsion polymer containing a vinyl amine polymer are disclosed within U.S. Pat. No. 5,492,765. Highly adhesive synthetic fiber materials which are capable of being firmly bonded to resinous matrix materials are disclosed within EP 0 430 054 to include a synthetic fiber coated with a poly(allyl amine) compound. A glazing laminate which includes at least one layer of a polyester film coated with a poly(allyl amine) material was disclosed in US Patent Application No. 2005/0129954. The coated polyester film was not, however, disclosed for use within solar cell modules.

The current invention overcomes the shortcomings of the art and provides solar cell modules which incorporate polyester films with high adhesion to the other laminate layers.

### SUMMARY OF THE INVENTION

This invention is directed to a solar cell module comprising, from top to bottom: (i) an incident layer, which is adjacent and laminated to, (ii) a front-sheet encapsulant layer, which is adjacent and laminated to, (iii) a solar cell layer comprising one or a plurality of electronically interconnected solar cells, which is adjacent and laminated to, (iv) an optional back-sheet encapsulant layer, which is adjacent and laminated to, (v) a back-sheet, wherein at least one of said incident layer, front-sheet encapsulant layer, back-sheet encapsulant layer, and back-sheet comprises one layer of a polyester film having at least one surface coated with a coating of polyolefin having at least one primary amine functional group, preferably, poly(allyl amine) or poly(vinyl amine). It is preferred that the polyester film is a bi-axially-oriented poly(ethylene terephthalate) film.

In one specific embodiment, the incident layer used in the present solar cell module comprises one layer of the polyester film which has its inner surface coated with the coating of polyolefin having at least one primary amine functional group and adhered to the front-sheet encapsulant layer. In addition, a light-receiving outer surface of the incident layer may be further coated with a barrier, antireflective and/or abrasion-resistant coating.

In another embodiment, the back-sheet used in the present solar cell module comprises one layer of the polyester film which has its inner surface coated with the coating of polyolefin having at least one primary amine functional group and adhered to the back-sheet encapsulant layer. In addition, a rear outer surface of the back-sheet may be further coated with a barrier, abrasion-resistant, and/or metal coating.

In yet another embodiment, the present solar cell module comprises an incident layer which contains a first layer of the primed polyester film and a back-sheet which contains a second layer of the primed polyester film.

In yet another embodiment, the front-sheet encapsulant layer used in the present solar cell module comprises one layer of the polyester film which has one or both of its surfaces coated with the coating of polyolefin having at least one primary amine functional group and laminated between two polymeric film or sheet layers. In addition, one or both surfaces of the polyester film may be further coated with a barrier coating.

In yet another embodiment, the back-sheet encapsulant layer used in the present solar cell module comprises one layer of the polyester film which has one or both of its surfaces coated with the coating of polyolefin having at least one primary amine functional group and laminated between two polymeric film or sheet layers. In addition, one or both surfaces of the polyester film may be further coated with a barrier coating.

In yet another embodiment, each of the front-sheet encapsulant layer and back-sheet encapsulant layer used in the present solar cell module comprises one layer of the polyester film laminated between two polymeric film or sheet layers.

In yet another embodiment, the present solar cell module comprises a front-sheet encapsulant layer which contains a first layer of the primed polyester film laminated between two polymeric film or sheet layers and a back-sheet which contains a second layer of the primed polyester film.

In another aspect, the present invention is directed to a process for preparing the solar cell modules described above.

### BRIEF DESCRIPTION OF THE DRAWINGS

FIG. 1 is a cross-sectional view of a polyester film (12) having one surface primed with a coating of polyolefin having at least one primary amine functional group (14), the combination of which being generally referred at (10).

FIG. 2 is a cross-sectional view of a polyester film (12) having both surfaces primed with a coating of polyolefin having at least one primary amine functional group (14), the combination of which being generally referred at (20).

FIG. 3 is a cross-sectional view of a typical solar cell module (30) comprising (i) an incident layer (31), (ii) a front-sheet encapsulant layer (32), (iii) a solar cell layer (33), (iv) a back-sheet encapsulant layer (34), and (v) a back-sheet (35).

FIG. 4 is a cross-sectional view of one particular embodiment of the present invention, wherein the solar cell module (40) comprises (i) an incident layer (31) comprising one layer of the primed polyester film (10), (ii) a front-sheet encapsulant layer (32), (iii) a solar cell layer (33), (iv) a back-sheet encapsulant layer (34), and (v) a back-sheet (35).

FIG. 5 is a cross-sectional view of another particular embodiment of the present invention, wherein the solar cell module (50) comprises (i) an incident layer (31), (ii) a front-sheet encapsulant layer (32), (iii) a solar cell layer (33), (iv) a back-sheet encapsulant layer (34), and (v) a back-sheet (35) comprising one layer of the primed polyester film (10).

FIG. 6 is a cross-sectional view of yet another particular embodiment of the present invention, wherein the solar cell module (60) comprises (i) an incident layer (31) comprising a first layer of the primed polyester film (10), (ii) a front-sheet encapsulant layer (32), (iii) a solar cell layer (33), (iv) a back-sheet encapsulant layer (34), and (v) a back-sheet (35) comprising a second layer of the primed polyester film (10).

FIG. 7 is a cross-sectional view of yet another particular embodiment of the present invention, wherein the solar cell module (70) comprises (i) an incident layer (31), (ii) a front-sheet encapsulant layer (32) comprising one layer of the primed polyester film (20) laminated between two polymeric film or sheet layers (32a and 32b), (iii) a solar cell layer (33), (iv) a back-sheet encapsulant layer (34), and (v) a back-sheet (35).

FIG. 8 is a cross-sectional view of yet another particular embodiment of the present invention, wherein the solar cell module (80) comprises (i) an incident layer (31), (ii) a front-sheet encapsulant layer (32), (iii) a solar cell layer (33), (iv) a back-sheet encapsulant layer (34) comprising one layer of the primed polyester film (20) laminated between two polymeric film or sheet layers (34a and 34b), and (v) a back-sheet (35).

FIG. 9 is a cross-sectional view of yet another particular embodiment of the present invention, wherein the solar cell module (90) comprises (i) an incident layer (31), (ii) a front-sheet encapsulant layer (32) comprising a first layer of the primed polyester film (20) laminated between two polymeric film or sheet layers (32a and 32b), (iii) a solar cell layer (33), (iv) a back-sheet encapsulant layer (34) comprising a second layer of the primed polyester film (20) laminated between two polymeric film or sheet layers (34a and 34b), and (v) a back-sheet (35).

FIG. 10 is a cross-sectional view of yet another particular embodiment of the present invention, wherein the solar cell module (100) comprises (i) an incident layer (31), (ii) a front-sheet encapsulant layer (32) comprising a first layer of the primed polyester film (20) laminated between two polymeric film or sheet layers (32a and 32b), (iii) a solar cell layer (33), (iv) a back-sheet encapsulant layer (34), and (v) a back-sheet (35) comprising a second layer of the primed polyester film (10).

### DETAILED DESCRIPTION OF THE INVENTION

To the extent permitted by the United States law, all publications, patent applications, patents, and other references mentioned herein are incorporated by reference in their entirety.

The materials, methods, and examples herein are illustrative only and the scope of the present invention should be judged only by the claims.

### Definitions

The following definitions apply to the terms as used throughout this specification, unless otherwise limited in specific instances.

Unless stated otherwise, all percentages, parts, ratios, etc., are by weight.

When the term “about” is used in describing a value or an end-point of a range, the disclosure should be understood to include the specific value or end-point referred to.

In the present application, the terms “sheet” and “film” are used in their broad sense interchangeably.

In describing and/or claiming this invention, the term “copolymer” is used to refer to polymers containing two or more monomers.

### Primed Polyester Films

The present invention relates to the use of primed polyester films in solar cell module or laminate constructions. The primed polyester films used herein and the process of producing the same have been disclosed in U.S. Pat. Nos. 5,411,845; 5,492,765; 5,690,994; 5,698,329; and 5,770,312, and US Patent Application No. 2005/0129954. However, such primed polyester films have not been used in solar cells prior to this invention.

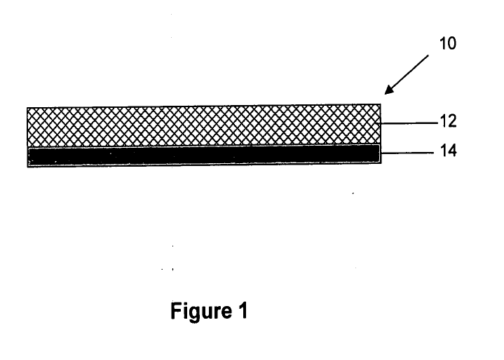

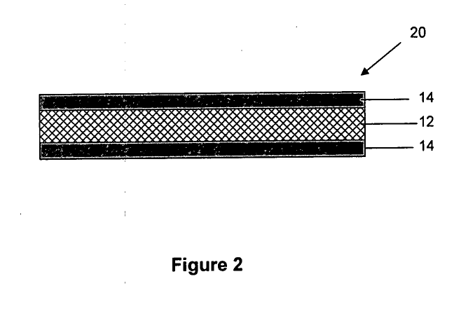

The primed polyester films used herein are prepared by applying a primer to one or both surfaces of the polyester film (FIGS. 1 and 2). The polyester film is preferably a poly(ethylene terephthalate) (PET) film. More preferably, the polyester film is an oriented polyester film. Most preferably, the polyester film is a bi-axially-oriented polyester film. The thickness of the polyester film is not critical and may be varied depending on the particular application. Generally, the thickness of the polyester film will range from about 0.1 to about 10 mils (about 0.003 to about 0.26 mm).

The primer used herein for priming the polyester films may comprise any polyolefin material having at least one primary amine functional group. Preferably, the primer comprises a poly(allyl amine), poly(vinyl amine), or combinations thereof. The primer may include additional comonomers, such as, N-substituted monoallyl amine or monovinyl amine comonomers. Preferable additional comonomers may include N-2-propenyl-2-propen-1-amine, N-methylallyl amine, N-ethylallylamine, N-n-propylallylamine, N-isopropylallylamine, N-n-butylallylamine, N-sec-butylallylamine, N-tertbutylallylamine, N-iso-butylallylamine, N-cyclohexylallylamine, N-benzylallylamine, vinyl alcohol, alpha olefins, ethylene, propylene, 1-butene, 1-pentene, 1-hexene, 1-heptene, 3-methyl-1-butene, 4-methyl-1-pentene, N-vinylformamide, N-vinylacetamide, acrylic acid, methacrylic acid, methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol)4-nonylphenyl ether acrylate, poly(ethylene glycol)4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimethyl fumarate, vinyl acetate, vinyl propionate, and the like and mixtures thereof.

Generally, the polyester film is extruded and cast as a film by conventional methods and the primer is applied to the polyester film either prior to stretching or between the machine direction stretching and the transverse direction stretching operations, and/or after the two stretching operations and heat setting in the tenter oven. It is preferable that the primer be applied prior to transverse stretching operation so that the primed polyester web is heated under restraint to a temperature of about 220° C. in the tenter oven in order to cure the primer to the polyester surface(s). In addition to this cured primer coating, an additional coating of primer may be applied on it after the stretching and tenter oven heat setting in order to obtain a thicker overall primer coating.

The polyester film is preferably sufficiently stress-relieved and shrink-stable under the coating and lamination processes. Preferably, the polyester film is heat stabilized to provide low shrinkage characteristics when subjected to elevated temperatures (i.e. less than 2% shrinkage in both directions after 30 min at 150° C.).

The primed polyester films may be further coated with additional coating materials and therefore useful as oxygen and/or moisture barrier layers. An example for such additional coating material is the metal oxide coating disclosed in U.S. Pat. Nos. 6,521,825 and 6,818,819 and European Patent No. EP 1 182 710. The primed polyester films used herein may also be metallized on at least one surface with, for example, aluminum.

The primed polyester films used herein may further include a hard coat coating on at least one surface, especially if the hard coated surface of the film forms an outside layer of the solar cell module. The hard coat may be, for example, an abrasion resistant polysiloxane material, an oligomeric coating or a UV-curable coating.

### Solar Cell Laminates Comprising Primed Polyester Films

In one aspect, the present invention is a solar cell module or laminate comprising at least one layer of a polyester film with one or both surfaces primed with a coating of polyolefin having at least one primary amine functional group, such as poly(allyl amine), poly(vinyl amine), or a combination thereof. The primed polyester film(s) may be used as or included in the incident layer, front-sheet encapsulant layer, back-sheet encapsulant layer, and/or back-sheet of the solar cell laminate.

### I. Solar Cell Modules or Laminates:

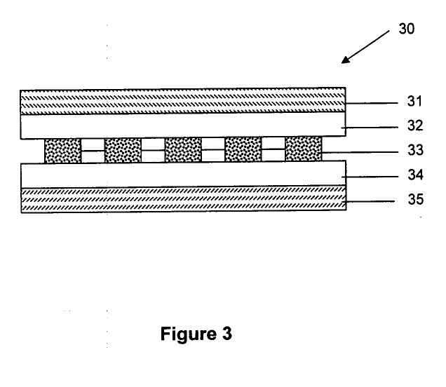

In accordance to the present invention, solar cell laminates or modules are formed of one or more solar cells laminated between a number of film or sheet structures. Referring now to FIG. 3, a typical solar cell laminate (30) includes, from top to bottom, (i) an incident layer (31) formed of light-transmitting material, (ii) a front-sheet encapsulant layer (32) formed of light-transmitting polymeric material, (iii) a solar cell layer (33) formed of one or more electronically interconnected solar cells, (iv) an optional back-sheet encapsulant layer (34) formed of polymeric material, and (v) a back-sheet (35) formed of glass, metal, or polymeric film(s) or sheet(s).

Solar (Photovoltaic) Cells

Solar cells are commonly available on an ever increasing variety as the technology evolves and is optimized. Within the present invention, a solar cell is meant to include any article which can convert light into electrical energy. Typical art examples of the various forms of solar cells include, for example, single crystal silicon solar cells, polycrystal silicon solar cells, microcrystal silicon, solar cells, amorphous silicon based solar cells, copper indium selenide solar cells, compound semiconductor solar cells, dye sensitized solar cells, and the like. The most common types of solar cells include multi-crystalline solar cells, thin film solar cells, compound semiconductor solar cells and amorphous silicon solar cells due to relatively low cost manufacturing ease for large scale solar cells.

Thin film solar cells are typically produced by depositing several thin film layers onto a substrate, such as glass or a flexible film with the layers being patterned so as to form a plurality of individual cells which are electrically interconnected to produce a suitable voltage output. Depending on the sequence in which the multi-layer deposition is carried out, the substrate may serve as the rear surface or as a front window for the solar cell module. By way of example, thin film solar cells are disclosed in U.S. Pat. Nos. 5,512,107; 5,948,176; 5,994,163; 6,040,521; 6,137,048; and 6,258,620. Examples of thin film solar cell modules are those that comprise cadmium telluride or CIGS, (Cu(In—Ga)(SeS)2), thin film cells.

Encapsulant Layers

Here again, referring to FIG. 3, In a solar cell module, the encapsulant layers (i.e., the front-sheet encapsulant layer (32) and the back-sheet encapsulant layer (34)) encapsulate the fragile solar cell(s) (33) and serve as barrier layers between the solar cell(s) and the outer surface layers, i.e., the incident layer (31) and the back-sheet (35).

The encapsulant layers may be formed of polymeric compositions, such as, acid copolymers, ethylene (meth)acrylic acid copolymer, ionomers, ethylene vinyl acetate (EVA), acoustic poly(vinyl acetal), acoustic poly(vinyl butyral), polyvinylbutyral (PVB), thermoplastic polyurethane (TPU), polyvinylchloride (PVC), metallocene-catalyzed linear low density polyethylenes, polyolefin block elastomers, ethylene acrylate ester copolymers (e.g., poly(ethylene-co-methyl acrylate) and poly(ethylene-co-butyl acrylate)), silicone elastomers, epoxy resins and combinations thereof.

In forming the encapsulant layers, various additives may be added into the polymeric compositions. It is understood that any additives known within the art may be used herein. Exemplary additives include, but are not limited to, melt flow reducing additives, initiators (e.g., dibutyltin dilaurate), inhibitors (e.g., hydroquinone, hydroquinone monomethyl ether, p-benzoquinone, and methylhydroquinone), plasticizers, processing aides, flow enhancing additives, lubricants, pigments, dyes, colorants, flame retardants, impact modifiers, nucleating agents, anti-blocking agents (e.g., silica), thermal stabilizers, UV absorbers, UV stabilizers, hindered amine light stabilizers (HALS), dispersants, surfactants, chelating agents, coupling agents, adhesives, primers, and reinforcement additives (e.g., glass fiber and fillers). Suitable melt flow reducing additives may include, but are not limited to, organic peroxides, such as 2,5-dimethylhexane-2,5-dihydroperoxide, 2,5-dimethyl-2,5-di(tert-betylperoxy)hexane-3, di-tert-butyl peroxide, tert-butylcumyl peroxide, 2,5-dimethyl-2,5-di(tert-butylperoxy)hexane, dicumyl peroxide, alpha, alpha′-bis(tert-butyl-peroxyisopropyl)benzene, n-butyl-4,4-bis(tert-butylperoxy)valerate, 2,2-bis(tert-butylperoxy)butane, 1,1-bis(tert-butyl-peroxy)cyclohexane, 1,1-bis(tert-butylperoxy)-3,3,5-trimethyl-cyclohexane, tert-butyl peroxybenzoate, benzoyl peroxide, and the like and mixtures combinations thereof. Preferable general classes of thermal stabilizers include, but are not limited to, phenolic antioxidants, alkylated monophenols, alkylthiomethylphenols, hydroquinones, alkylated hydroquinones, tocopherols, hydroxylated thiodiphenyl ethers, alkylidenebisphenols, O- , N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. Preferable general classes of UV absorbers include, but are not limited to, benzotriazoles, hydroxybenzophenones, hydroxyphenyl triazines, esters of substituted and un-substituted benzoic acids, and the like and mixtures thereof. Generally, HALS are secondary, tertiary, acetylated, N-hydrocarbyloxy substituted, hydroxy substituted, N-hydrocarbyloxy substituted, or other substituted cyclic amines which further incorporate steric hindrance, generally derived from aliphatic substitution on the carbon atoms adjacent to the amine function. The practice of the above mentioned additives is well known to those skilled in the art. In general, depending on the particular application, the encapsulant layers used herein may contain any one or more suitable additives which are known or yet to be known within the art.

In accordance to the present invention, the solar cell encapsulant layers used herein may be in the form of single layer or multilayer. By multilayer, it is meant that the solar cell encapsulant includes more than one layer of polymeric film or sheet. One advantage to multilayer encapsulant layers is that specific properties can be tailored into the film and sheet to solve critical use needs while allowing the more costly ingredients to be relegated to the outer layers where they provide the greater needs. The multilayer encapsulant layers may be varied through each layer's composition, each layer's thickness and the positioning of the various layers within the multilayer film or sheet. For example, in a tri-layer construct, the surface, layers derived from certain acid copolymers or ionomers may enhance the adhesion, anti-block or physical properties of the structure while the middle layer may provide optical clarity, structural support, shock absorbance, and the like or simply to provide a more cost efficient structure.

The solar cell encapsulant layer films and sheets may be produced through any known process. The multilayer solar cell encapsulant layer films and sheets, may be produced through the use of preformed films and sheets, laminates thereof, extrusion coated multilayer films or sheets, coextrusion casting and blown film processes. Generally, the solar cell encapsulant layer films and sheets are produced through extrusion casting or blown film processes. The encapsulant layer may have smooth or roughened surfaces, such as through surface embossment. Preferably, the encapsulant layers have roughened surfaces. One factor affecting the appearance of the front-sheet portion of the solar cell laminates is whether the laminate includes trapped air or air bubbles that develop between the encapsulant layer and the incident layer or the solar cell layer, for example. It is desirable to remove air in an efficient manner during the lamination process. Providing channels for the escape of air and removing air during lamination is a known method for obtaining laminates having acceptable appearance. This may be effected by mechanically embossing or by melt fracture during extrusion the encapsulant layer sheet followed by quenching so that the roughness is retained during handling. Retention of the surface roughness is preferred to facilitate effective de-airing of the entrapped air during laminate preparation.

The solar cell encapsulant layers used herein may have a thickness of from about 0.1 to about 240 mils (about 0.003 to about 6.1 mm). The thinner solar cell encapsulant films, for example, with a thickness of from about 0.1 to about 5 mils (about 0.003 to about 0.13 mm) are generally utilized within flexible solar cell laminates. On the other hand, the thicker solar cell encapsulant sheets, for example, with a thickness of from about 10 to about 20 mils (about 0.25 to about 0.51 mm) are generally utilized within rigid solar cell laminates. Even thicker encapsulant layers, such as those with a thickness of from about 20 to about 240 mils (about 0.51 to about 6.1 mm) may be utilized when it is desired for the solar cell module to additionally take on the attributes normally considered for safety glass. The thickness of the individual film and sheet components which make up the total multilayer encapsulant layer of the present invention is not critical and may be independently varied depending on the particular application.

If desired, one or both surfaces of the encapsulant film and sheet layer may be treated to enhance the adhesion to other laminate layers. This treatment may take any form known within the art, including adhesives, primers, such as silanes, flame treatments (which are disclosed in U.S. Pat. Nos. 2,632,921; 2,648,097; 2,683,894; and 2,704,382), plasma treatments (which are disclosed in U.S. Pat. No. 4,732,814), electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof.

In accordance to the present invention, the compositions and/or the thickness of the front-sheet and back-sheet encapsulant layers in a particular solar cell laminate may be the same or different and distinct. In addition, the front-sheet encapsulant layer must be transparent to allow the penetration of light. In some particular embodiments, the back-sheet encapsulant layer could be optional. That is, in some particular solar cell modules, the non-light-receiving surface of the solar cell layer may be in direct contact with the back-sheet structure.

Incident Layers, Back-Sheets, and Other Additional Layers

Here again, referring to FIG. 3, the solar cell modules or laminates disclosed herein may further comprise one or more sheet layers or film layers to serve as the incident layer (31), the back-sheet layer (35), and other additional layers. In the present invention, the incident layer (31) is formed of light-transmitting material, such as glass or transparent polymeric film(s) or sheet(s), while the back-sheet layer (35) is formed of film(s) or sheet(s) strong enough to provide support to the solar cell module structure.

The sheet layers, such as the incident and back-sheet layers, used herein may be glass or plastic sheets, such as, polycarbonate, acrylics, polyacrylate, cyclic polyolefins, such as ethylene norbornene polymers, metallocene-catalyzed polystyrene, polyamides, polyesters, fluoropolymers and the like and combinations thereof, or metal sheets, such as aluminum, steel, galvanized steel, and ceramic plates. Glass may serve as the incident layer of the solar cell laminate and the supportive back-sheet of the solar cell module may be derived from glass, rigid plastic sheets or metal sheets.

The term “glass” is meant to include not only window glass, plate glass, silicate glass, sheet glass, low iron glass, tempered glass, tempered CeO-free glass, and float glass, but also includes colored glass, specialty glass which includes ingredients to control, for example, solar heating, coated glass with, for example, sputtered metals, such as silver or indium tin oxide, for solar control purposes, E-glass, Toroglass, Solex® glass (a product of Solutia) and the like. Such specialty glasses are disclosed in, for example, U.S. Pat. Nos. 4,615,989; 5,173,212; 5,264,286; 6,150,028; 6,340,646; 6,461,736; and 6,468,934. The type of glass to be selected for a particular laminate depends on the intended use.

The film layers, such as the incident, back-sheet or other layers, used herein may be metal, such as aluminum foil, or polymeric. Preferable polymeric film materials include poly(ethylene terephthalate), polycarbonate, polypropylene, polyethylene, polypropylene, cyclic polyolefins, norbornene polymers, polystyrene, syndiotactic polystyrene, styrene-acrylate copolymers, acrylonitrile-styrene copolymers, poly(ethylene naphthalate), polyethersulfone, polysulfone, nylons, poly(urethanes), acrylics, cellulose acetates, cellulose triacetates, cellophane, vinyl chloride polymers, polyvinylidene chloride, vinylidene chloride copolymers, fluoropolymers, polyvinyl fluoride, polyvinylidene fluoride, polytetrafluoroethylene, ethylene-tetrafluoroethylene copolymers and the like. Most preferably, the polymeric film is bi-axially oriented poly(ethylene terephthalate) (PET) film, aluminum foil, or a fluoropolymer film, such as Tedlar® or Tefzel® films, which are commercial products of the E. I. du Pont de Nemours and Company. The polymeric film used herein may also be a multi-layer laminate material, such as a fluoropolymer/polyester/fluoropolymer (e.g., Tedlar®/Polyester/Tedlar®) laminate material or a fluoropolymer/polyester/EVA laminate material.

The thickness of the polymeric film is not critical and may be varied depending on the particular application. Generally, the thickness of the polymeric film will range from about 0.1 to about 10 mils (about 0.003 to about 0.26 mm). The polymeric film thickness may be preferably within the range of about 1 and about 4 mils (about 0.025 and about 0.1 mm).

The polymeric film is preferably sufficiently stress-relieved and shrink-stable under the coating and lamination processes. Preferably, the polymeric film is heat stabilized to provide low shrinkage characteristics when subjected to elevated temperatures (i.e. less than 2% shrinkage in both directions after 30 min at 150°).

The films used herein may serve as the incident layer (such as the fluoropolymer or poly(ethylene terephthalate) film) or the back-sheet (such as the fluoropolymer, aluminum foil, or poly(ethylene terephthalate) film). The films may also be included in the present solar cell module as dielectric layers or a barrier layers, such as oxygen or moisture barrier layers.

If desired, a layer of non-woven glass fiber (scrim) may be included in the present solar cell laminate to facilitate de-airing during the lamination process or to serve as reinforcement for the encapsulant layer(s). The use of such scrim layers within solar cell laminates is disclosed within, for example, U.S. Pat. Nos. 5,583,057; 6,075,202; 6,204,443; 6,320,115; 6,323,416; and European Patent No. 0 769 818.

### II. Solar Cell Modules Comprising Primed Polyester Films as Incident Layers and/or Back-Sheets:

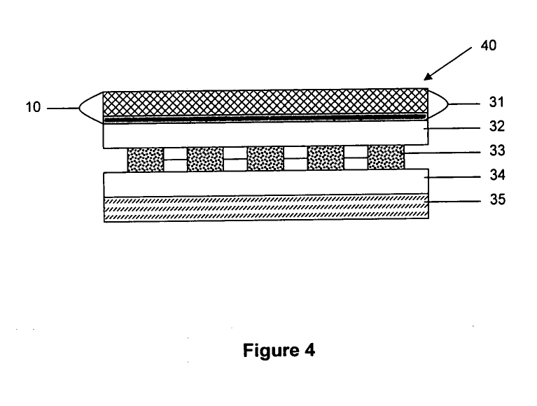

Now referring to FIGS. 4-6, the solar cell laminate of the present invention may comprise one or more primed polyester films as the incident layer (31) and/or the back-sheet layer (35).

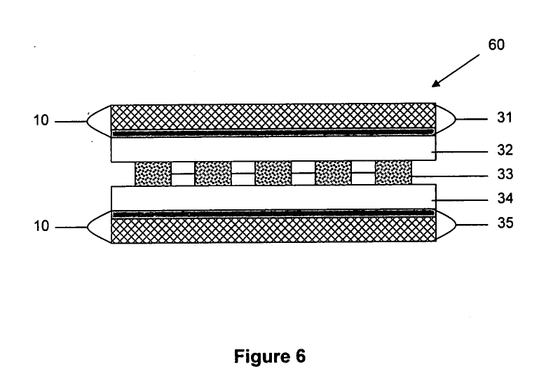

When the polyester film is included as an, incident layer (31) in the solar cell module, it is preferred that the inner surface of the polyester film, which is adjacent to the front-sheet encapsulant layer (32), is coated with the coating of polyolefin having at least one primary amine functional group (FIGS. 4 and 6). Additionally, barrier coatings, antireflective coatings, and/or abrasive-resistant coatings, as disclosed above, may be further applied to both surfaces, or preferably the light-receiving outer surface of the primed polyester film (10).

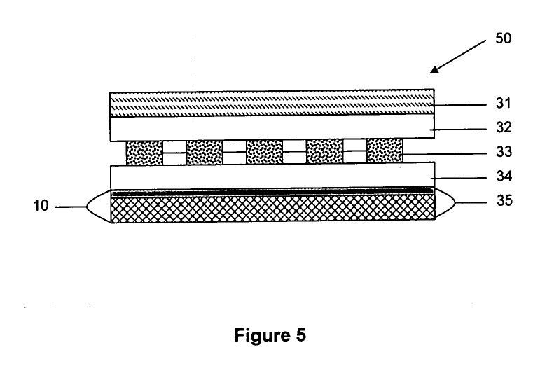

In those embodiments (FIGS. 5 and 6) where the polyester film is included in the solar cell module as a back-sheet layer (35), it is preferred that the coating of polyolefin having at least one primary amine functional group is deposited on the inner surface that is adjacent to the back-sheet encapsulant layer (34). Barrier coatings, metal coatings, and/or abrasive-resistant coatings may be further applied to both surfaces, or preferably the rear outer surface of the primed polyester film (10).

Also within the scope of the present invention, both the incident and back-sheet layers (31 and 35) within a solar cell module may be formed of the primed polyester films (FIG. 6).

### III. Solar Cell Modules Comprising Primed Polyester Films Embedded in Encapsulant Layers:

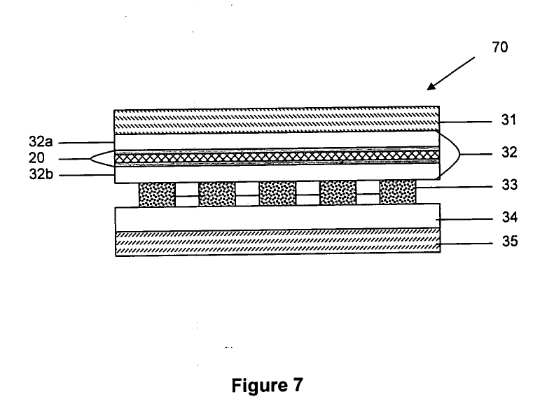

In another embodiment of the present invention, the solar cell module disclosed herein includes one or more primed polyester films embedded in the encapsulant layer(s) (FIGS. 7-9). In these embodiments, the primed polyester films are included as component sub-layers of the encapsulant layer(s). It is preferred that the primed polyester films used herein have both surfaces coated with the coating of polyolefin having at least one primary amine functional group (FIG. 2). Moreover, it is preferred that the primed polyester films used herein are not in direct contact with either the solar cell layer or the outer surface layers (i.e., the incident and the back-sheet layers). In another word, the primed polyester films are preferred to be laminated between the other polymeric film or sheet layers that make up the encapsulant layers. In addition, one, or preferably, both surfaces of the primed polyester film(s) are further primed with one or more barrier coatings. The inclusion of the primed polyester film(s) in the encapsulant layer(s) provides additional oxygen and/or moisture barriers for the solar cells. Additionally, in an embodiment wherein the back-sheet (35) is formed of galvanized steel or aluminum foil, the primed polyester film embedded in the back-sheet encapsulant layer (34) may also serve as a dielectric layer between the solar cell layer (33) and the metal back-sheet (35).

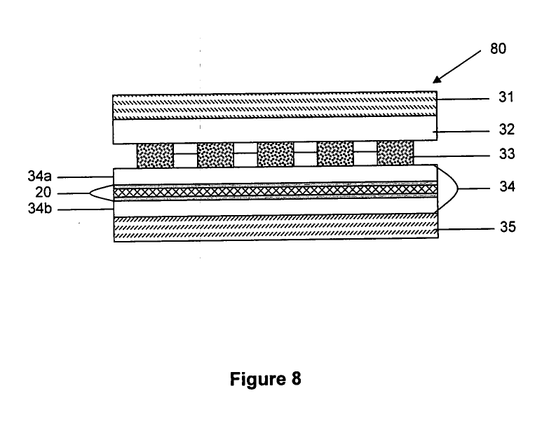

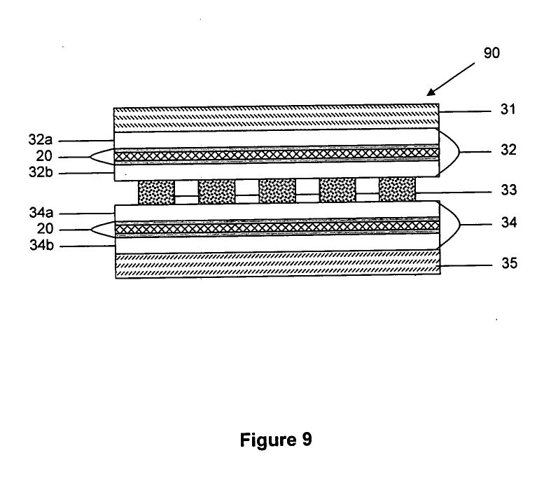

FIG. 7 shows one specific embodiment, wherein the primed polyester film layer (20) is laminated between two polymeric film or sheet layers (32a and 32b) and embedded in the front-sheet encapsulant layer (32). FIG. 8 shows another embodiment, wherein the primed polyester film layer (20) is laminated between two polymeric film or sheet layers (34a and 34b) and embedded in the back-sheet encapsulant layer (34). FIG. 9 shows yet another embodiment, wherein a first layer of the primed polyester film (20) is laminated between two polymeric film or sheet layers (32a and 32b) and embedded in the front-sheet encapsulant layer (32) and a second layer of the primed polyester film (20) laminated between two polymeric film or sheet layers (34a and 34b) and embedded in the back-sheet encapsulant layer (34).

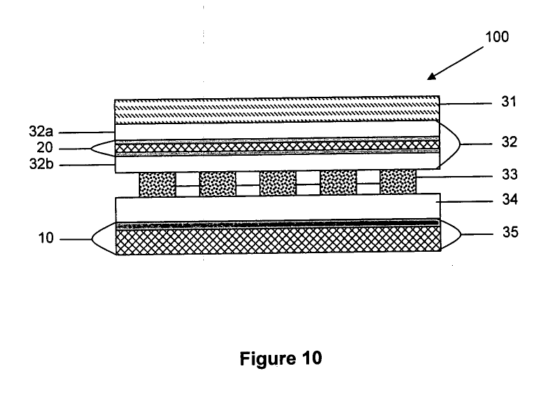

Also within the scope of the present invention is an embodiment (FIG. 10) wherein the solar cell module (100) comprises a first layer of the primed polyester film (20) laminated between two polymeric film or sheet layers (32a and 32b) and embedded in the front-sheet encapsulant layer (32) and a second layer of the primed polyester film (10) as the back-sheet (35). In this embodiment, the first layer of the primed polyester film may be further coated with one or more barrier coating on one or bother surfaces and the second layer of the primed polyester film may be further coated with one or more barrier, abrasive-resistant, and/or metal coatings on one or both surfaces.

### IV. Solar Cell Module Constructs:

The solar cell laminates of the present invention may take any form known within the art. For brevity, the above mentioned primed polyester film layers are abbreviated as “P-PET”. Preferable specific solar cell laminate constructions (top (light incident) side to back side) include, for example, glass/encapsulant layer/P-PET film/encapsulant layer/solar cell/encapsulant layer/glass; glass/encapsulant layer/P-PET film/encapsulant layer/solar cell/encapsulant layer/P-PET film/encapsulant layer/glass; glass/encapsulant layer/P-PET film/encapsulant layer/solar cell/encapsulant layer/TEDLAR film; TEDLAR film/encapsulant layer/solar cell/encapsulant layer/P-PET film; P-PET film/encapsulant layer/solar cell/encapsulant layer/P-PET film; glass/encapsulant layer/solar cell/encapsulant layer/P-PET film; glass/encapsulant layer/solar cell/encapsulant layer/P-PET film/encapsulant layer/aluminum foil; TEDLAR film/encapsulant layer/solar cell/encapsulant layer/P-PET film/encapsulant layer/aluminum foil; glass/encapsulant layer/solar cell/encapsulant layer/P-PET film/encapsulant layer/galvanized steel sheet; TEDLAR/encapsulant layer/solar cell/encapsulant layer/P-PET film/encapsulant layer/galvanized steel sheet and the like.

### Solar Cell Lamination Process

In another aspect, the present invention is a process for preparing the solar cell modules or laminates described above.

Notably, the solar cell laminates of the present invention may be produced through autoclave and non-autoclave processes, as described below. For example, the solar cell constructs described above may be laid up in a vacuum lamination press and laminated together under vacuum with heat and standard atmospheric or elevated pressure. Alternatively, the solar cell laminates may be formed by conventional autoclave processes.

For example, in a typical process, a glass sheet, a first layer of a front-sheet encapsulant layer, a P-PET film, a second layer of a front-sheet encapsulant layer, a solar cell, a back-sheet encapsulant layer, Tedlar® film, and a cover glass sheet are laminated together under heat and pressure and a vacuum (for example, in the range of about 27 to about 28 inches (about 689 to about 711 mmHg) to remove air. Preferably, the glass sheet has been washed and dried. A typical glass type is about 90 mil thick annealed low iron glass. In a typical procedure, the laminate assembly of the present invention is placed into a bag capable of sustaining a vacuum (“a vacuum bag”), drawing the air out of the bag using a vacuum line or other means of pulling a vacuum on the bag, sealing the bag while maintaining the vacuum, placing the sealed bag in an autoclave at a temperature of about 120° C. to about 180° C., at a pressure of about 200 psi (about 15 bars), for from about 10 to about 50 minutes. Preferably the bag is autoclaved at a temperature of from about 120° C. to about 160° C. for 20 minutes to about 45 minutes. More preferably the bag is autoclaved at a temperature of from about 135° C. to about 160° C. for about 20 minutes to about 40 minutes. A vacuum ring may be substituted for the vacuum bag. One type of vacuum bags is disclosed within U.S. Pat. No. 3,311,517.

Any air trapped within the laminate assembly may be removed through a nip roll process. For example, the laminate assembly may be heated in an oven at about 80° C. to about 120° C., preferably about 90° C. to about 100° C., for about 30 minutes. Thereafter, the heated laminate assembly is passed through a set of nip rolls so that the air in the void spaces between the solar cell outside layers, the solar cell and the encapsulant layers may be squeezed out, and the edge of the assembly sealed. This process may provide the final solar cell laminate or may provide what is referred to as a pre-press assembly, depending on the materials of construction and the exact conditions utilized.

The pre-press assembly may then be placed in an air autoclave where the temperature is raised to about 120° C. to about 160° C., preferably to about 135° C. to about 160° C., and pressure of about 100 to about 300 psig, preferably about 200 psig (about 14.3 bar). These conditions are maintained for about 15 minutes to about 1 hour, preferably about 20 minutes to about 50 minutes, after which, the air is cooled while no more air is added to the autoclave. After about 20 minutes of cooling, the excess air pressure is vented and the solar cell laminates are removed from the autoclave. This should not be considered limiting. Essentially any suitable process known within the art may be used in laminating the assembly.

The laminates of the present invention may also be produced through non-autoclave processes. Such non-autoclave processes are disclosed, for example, within U.S. Pat. Nos. 3,234,062; 3,852,136; 4,341,576; 4,385,951; 4,398,979; 5,536,347; 5,853,516; 6,342,116; 5,415,909, US Patent Application No. 2004/0182493, European Patent No. EP 1 235 683 B1, and PCT Patent Application Nos. WO 91/01880 and WO 03/057478 A1. Generally, the non-autoclave processes include heating the laminate assembly or the pre-press assembly and the application of vacuum, pressure or both. For example, the pre-press may be successively passed through heating ovens and nip rolls.

As desired, the edges of the solar cell module may be sealed to reduce moisture and air intrusion and their potentially degradation effect on the efficiency and lifetime of the solar cell. General art edge seal materials include, but are not limited to, butyl rubber, polysulfide, silicone, polyurethane, polypropylene elastomers, polystyrene elastomers, block elastomers, styrene-ethylene-butylene-styrene (SEBS), and the like.

### EXAMPLES

The following Examples are intended to be illustrative of the present invention, and are not intended in any way to limit the scope of the present invention. The solar cell interconnections are omitted from the examples below to clarify the structures, but any common art solar cell interconnections may be utilized within the present invention.

### Methods

The following methods are used in the Examples and Comparative Examples presented hereafter.

### I. Lamination Process 1:

The laminate layers described below are stacked (laid up) to form the pre-laminate structures described within the examples. For the laminate containing a film layer as the incident or back-sheet layer, a cover glass sheet is placed over the film layer. The pre-laminate structure is then placed within a vacuum bag, the vacuum bag is sealed and a vacuum is applied to remove the air from the vacuum bag. The bag is placed into an oven and while maintaining the application of the vacuum to the vacuum bag, the vacuum bag is heated at 135° C. for 30 minutes. The vacuum bag is then removed from the oven and allowed to cool to room temperature (25±5° C.). The laminate is then removed from the vacuum bag after the vacuum is discontinued.

### II. Lamination Process 2:

The laminate layers described below are stacked (laid up) to form the pre-laminate structures described within the examples. For the laminate containing a film layer as the incident or back-sheet layer, a cover glass sheet is placed over the film layer. The pre-laminate structure is then placed, within a vacuum bag, the vacuum bag is sealed and a vacuum is applied to remove the air from the vacuum bag. The bag is placed into an oven and heated to 90-100° C. for 30 minutes to remove any air contained between the assembly. The pre-press assembly is then subjected to autoclaving at 135° C. for 30 minutes in an air autoclave to a pressure of 200 psig (14.3 bar), as described above. The air is then cooled while no more air is added to the autoclave. After 20 minutes of cooling when the air temperature reaches less than about 50° C., the excess pressure is vented, and the laminate is removed from the autoclave.

### Examples 1-17

The 12-inch by 12-inch solar cell laminate structures described below in Table 1 are assembled and laminated by Lamination Process 1, as described above. Layers 1 and 2 constitute the incident layer and the front-sheet encapsulant layer, respectively, and Layers 4 and 5 constitute the back-sheet encapsulant layer and the back-sheet, respectively.

TABLE 1
Solar Cell Laminate Structures

| Example | Layer 1 | Layer 2 | Layer 3 | Layer 4 | Layer 5 |
|---|---|---|---|---|---|
| 1, 18 | Glass 1 | Ionomer 1 | Solar Cell 1 | EVA 1 | P-PET 1 |
| 2, 19 | Glass 2 | Ionomer 2 | Solar Cell 2 | PVB 1 | P-PET 2 |
| 3, 20 | Glass 1 | Ionomer 2 | Solar Cell 3 | Ionomer 2 | P-PET 3 |
| 4, 21 | Glass 2 | EVA 1 | Solar Cell 4 | EVA 1 | P-PET 4 |
| 5, 22 | Glass 1 | PVB 1 | Solar Cell 1 | PVB 1 | P-PET 5 |
| 6, 23 | Glass 1 | Ionomer 3 | Solar Cell 2 | EVA 2 | P-PET 6 |
| 7, 24 | Glass 3 | PVB A | Solar Cell 3 | PVB 2 | P-PET 3 |
| 8, 25 | FPF | Ionomer 4 | Solar Cell 4 | EVA 3 | P-PET 4 |
| 9, 26 | P-PET 3 | Ionomer 4 | Solar Cell 1 | Ionomer 4 | P-PET 5 |
| 10, 27 | P-PET 4 | EVA 3 | Solar Cell 2 | EVA 3 | P-PET 6 |
| 11, 28 | P-PET 3 | Ionomer 4 | Solar Cell 3 | Ionomer 4 | P-PET 3 |
| 12, 29 | FPF | EBA | Solar Cell 4 | EBA | P-PET 5 |
| 13, 30 | Glass 1 | Ionomer 5 | Solar Cell 1 | ACR 1 | P-PET 6 |
| 14, 31 | P-PET 3 | Ionomer 6 | Solar Cell 4 | EBA | AL |
| 15, 32 | P-PET 4 | EMA | Solar Cell 1 | ACR 2 | AL |
| 16, 33 | P-PET 3 | EMA | Solar Cell 4 | EMA | AL |
| 17, 34 | P-PET 3 | Ionomer 4 | Solar Cell 1 | ACR 3 | Glass 2 |

ACR 1 is a 20 mil (0.51 mm) thick embossed sheet of a poly(ethylene-co-methacrylic acid) containing 15 wt % of polymerized residues of methacrylic acid and having a MI of 5.0 g/10 minutes (190° C., ISO 1133, ASTM D1238).
ACR 2 is a 20 mil (0.51 mm) thick embossed sheet of a poly(ethylene-co-methacrylic acid) containing 18 wt % of polymerized residues of methacrylic acid and having a MI of 2.5 g/10 minutes (190° C., ISO 1133, ASTM D1238).
ACR 3 is a 2 mil (0.05 mm) thick embossed sheet of a poly(ethylene-co-methacrylic acid) containing 21 wt % of polymerized residues of methacrylic acid and having a MI of 5.0 g/10 minutes (190° C., ISO 1133, ASTM D1238).
AL is an aluminum sheet (3.2 mm thick) and is 5052 alloyed with 2.5 wt % of magnesium and conforms to Federal specification QQ-A-250/8 and ASTM B209.
EBA is a formulated composition based on poly(ethylene-co-butyl acrylate) containing 20 wt % of polymerized residues of butyl acrylate based on the total weight of the copolymer in the form of a 20 mil (0.51 mm) thick sheet.
EMA is a formulated composition based on poly(ethylene-co-methyl acrylate) containing 20 wt % of polymerized residues of methyl acrylate based on the total weight of the copolymer in the form of a 20 mil (0.51 mm) thick sheet.
EVA 1 is SC50B, believed to be a formulated composition based on poly(ethylene-co-vinyl acetate) in the form of a 20 mil (0.51 mm) thick sheet, a product of the Hi-Sheet Corporation (formerly Mitsui Chemicals Fabro, Inc.).
EVA 2 is an EVASAFE ethylene vinyl acetate sheet layer, a product of the Bridgestone Company, having a thickness of 17 mil (0.43 mm).
EVA 3 is a formulated composition based on poly(ethylene-co-vinyl acetate) in the form of a 2 mil (0.05 mm) thick film.
FPF is a corona surface treated Tedlar ® film having a thickness of 1.5 mil (0.038 mm), a product of the DuPont Corporation.
Glass 1 is Starphire ® glass from the PPG Corporation.
Glass 2 is a clear annealed float glass plate layer having a thickness of 2.5 mm.
Glass 3 in a Solex ® solar control glass having a thickness of 3.0 mm.
Ionomer 1 is a 20 mil (0.51 mm) thick embossed sheet of a poly(ethylene-co-methacrylic acid) containing 15 wt % of polymerized residues of methacrylic acid that is 35% neutralized with zinc ion and having a MI of 5 g/10 minutes (190° C., ISO 1133, ASTM D1238). Ionomer 1 is prepared from a poly(ethylene-co-methacrylic acid) having a MI of 60 g/10 minutes.
Ionomer 2 is a 20 mil (0.51 mm) thick embossed sheet of a poly(ethylene-co-methacrylic acid) containing 18 wt % of polymerized residues of methacrylic acid that is 35% neutralized sodium ion and having a MI of 2.5 g/10 minutes (190° C., ISO 1133, ASTM D1238). Ionomer 2 is prepared from a poly(ethylene-co-methacrylic acid) having a MI of 60 g/10 minutes.
Ionomer 3 is a 90 mil (2.25 mm) thick embossed sheet of a poly(ethylene-co-methacrylic acid) having 18 wt % of polymerized residues of methacrylic acid that is 30% neutralized with zinc ion and having a MI of 1 g/10 minutes (190° C., ISO 1133, ASTM D1238). Ionomer 3 is prepared from a poly(ethylene-co-methacrylic acid) having a MI of 60 g/10 minutes.
Ionomer 4 is a 2 mil (0.05 mm) thick film of the same copolymer of Ionomer 3.
Ionomer 5 is a 20 mil (0.51 mm) thick embossed sheet of a poly(ethylene-co-methacrylic acid) containing 20 wt % of polymerized residues of methacrylic acid that is 28% neutralized with zinc ion and having a MI of 1.5 g/10 minutes (190° C., ISO 1133, ASTM D1238). Ionomer 5 is prepared from a poly(ethylene-co-methacrylic acid) having a MI of 25 g/10 minutes.
Ionomer 6 is a 20 mil (0.51 mm) thick embossed sheet of a poly(ethylene-co-methacrylic acid) containing 22 wt % of polymerized residues of methacrylic acid that is 26% neutralized with zinc ion and having a MI of 0.75 g/10 minutes (190° C., ISO 1133, ASTM D1238). Ionomer 6 is prepared from a poly(ethylene-co-methacrylic acid) having a MI of 60 g/10 minutes.
P-PET 1 is a poly(ethylene terephthalate) film coated with a poly(allyl amine) primer composition as described for the “Primer” in US Patent Application No. 2005/0129954, Example 1.
P-PET 2 is a poly(ethylene terephthalate) film coated with a poly(vinyl amine) primer composition similar to that described for the “Primer” in US Patent Application No. 2005/0129954, Example 1.
P-PET 3 is a poly(ethylene terephthalate) film coated on one surface with a poly(allyl amine) primer composition and coated on the other surface with a polysiloxane abrasion resistant coating as described in US Patent Application No. 2005/0129954, Example 5. The poly(allyl amine)-coated film surface is placed in contact with the encapsulant layer and the polysiloxane-coated surface serves as the outside surface for the solar cell laminate.
P-PET 4 is a poly(ethylene terephthalate) film coated on one surface with a poly(vinyl amine) primer composition and coated on the other surface with a polysiloxane abrasion resistant coating similar to that described in US Patent Application No. 2005/0129954, Example 5. The poly(vinyl amine)-coated film surface is placed in contact with the encapsulant layer and the polysiloxane-coated surface serves as the outside surface for the solar cell laminate.
P-PET 5 is a poly(ethylene terephthalate) film coated with a poly(vinyl amine) primer composition similar to that described for the “Primer” in US Patent Application No. 2005/0129954, Example 1, and then one surface of the primed poly(ethylene terephthalate) film is metallized with aluminum. The poly(vinyl amine)-coated film surface is placed in contact with the encapsulant layer and the metallized surface serves as the outside surface for the solar cell laminate.
P-PET 6 is a poly(ethylene terephthalate) film coated with a poly(vinyl amine) primer composition similar to that described for the “Primer” in US Patent Application No. 2005/0129954, Example 1, and then one surface of the primed poly(ethylene terephthalate) film is metallized with aluminum. The poly(vinyl amine)-coated film surface is placed in contact with the encapsulant layer and the metallized surface serves as the outside surface for the solar cell laminate.
PVB 1 is B51V, believed to be a formulated composition based on poly(vinyl butyral) in the form of a 20 mil (0.51 mm) thick sheet (a product of the DuPont Corporation).
PVB 2 is B51S, believed to be a formulated composition based on poly(vinyl butyral) in the form of a 20 mil (0.51 mm) thick sheet (a product of the DuPont Corporation).
PVB A is an acoustic poly(vinyl butyral) sheet containing 100 parts per hundred (pph) poly(vinyl butyral) with a hydroxyl number of 15 plasticized with 48.5 pph plasticizer tetraethylene glycol diheptanoate prepared similarly to those disclosed within PCT Patent Application No. WO 2004/039581.
Solar Cell 1 is a 10-inch by 10-inch amorphous silicon photovoltaic device comprising a stainless steel substrate (125 micrometers thick) with an amorphous silicon semiconductor layer (U.S. Pat. No. 6,093,581, Example 1).
Solar Cell 2 is a 10-inch by 10-inch copper indium diselenide (CIS) photovoltaic device (U.S. Pat. No. 6,353,042, column 6, line 19).
Solar Cell 3 is a 10-inch by 10-inch cadmium telluride (CdTe) photovoltaic device (U.S. Pat. No. 6,353,042, column 6, line 49).
Solar Cell 4 is a silicon solar cell made from a 10-inch by 10-inch polycrystalline EFG-grown wafer (U.S. Pat. No. 6,660,930, column 7, line 61).

The embossed sheet structures noted above are prepared on an extrusion sheeting line equipped with embossing rolls utilizing common art sheet formation processes. This essentially entailed the use of an extrusion line consisting of a twin-screw extruder with a sheet die feeding melt into a calendar roll stack. The calendar rolls have an embossed surface pattern engraved into the metal surface which imparts to varying degrees a reverse image of the surface texture onto the polymer melt as it passes between and around the textured rolls. Both surfaces of the sheet are embossed with a pattern with the following characteristics:

Mound average depth: 21±4 micron;

Mound peak depth: 25±5 micron;

Pattern frequency/mm: 2;

Mound width: 0.350±0.02 mm; and

Valley width: 0.140±0.02 mm.

Surface roughness, Rz, can be expressed in microns by a 10-point average roughness in accordance with ISO-R468 of the International Organization for Standardization. Roughness measurements are made using a stylus-type profilometer (SURFCOM 1500A manufactured by Tokyo Seimitsu Kabushiki Kaisha of Tokyo, Japan) as described in ASME B46.1-1995 using a trace length of 26 mm. ARp and ARt, and the area kurtosis are measured by tracing the roughness over a 5.6 mm×5.6 mm area in 201 steps using the Perthometer Concept system manufactured by Mahr GmbH, Gottingen, Germany. The sheet is found to have an Rz in the range of from about 15 to about 25 micron.

### Examples 18-34

The 12-inch by 12-inch solar cell laminate structures described above in Table 1 are assembled and laminated by Lamination Process 2, as described above.

### Examples 35-46

The 12-inch by 12-inch solar cell laminate structures described below in Tables 2-4 are assembled and laminated by Lamination Process 1, as described above. In Examples 35-42, Layer 1 constitutes the incident layer, Layers 2, 3, and 4 constitute the front-sheet encapsulant layer, Layer 6 constitutes the back-sheet encapsulant layer, and Layer 7 constitutes the back-sheet. In Examples 43-46, Layer 1 constitutes the incident layer, Layers 2, 3, and 4 constitute the front-sheet encapsulant layer, Layer 6, 7, and 8 constitute the back-sheet encapsulant layer, and Layer 9 constitutes the back-sheet.

TABLE 2
Solar Cell Laminate Structures

| | Example | | | |
|---|---|---|---|---|
| Layer | 35, 47 | 36, 48 | 37, 49 | 38, 50 |
| 1 | Glass 1 | FPF | Glass 1 | Glass 2 |
| 2 | EVA 2 | EVA 3 | Ionomer 5 | Ionomer 6 |
| 3 | P-PET 1 | P-PET 7 | Solar Cell 3 | Solar Cell 4 |
| 4 | EVA 2 | EVA 1 | Ionomer 4 | Ionomer 6 |
| 5 | Solar Cell 1 | Solar Cell 2 | P-PET 8 | P-PET 2 |
| 6 | EVA 2 | EVA 1 | Ionomer 5 | Ionomer 6 |
| 7 | Glass 1 | Glass 2 | FPF | AL |

P-PET 7 is a poly(ethylene terephthalate) film coated on one surface with a poly(vinyl amine) primer composition and coated on the other surface with a moisture resistant coating similar to that described in U.S. Pat. No. 6,521,825, Example 1.
P-PET 8 is a poly(ethylene terephthalate) film coated on one surface with a poly(allyl amine) primer composition and coated on the other surface with a moisture resistant coating similar to that described in U.S. Pat. No. 6,521,825, Example 1.

TABLE 3
Solar Cell Laminate Structures

| | Example | | | |
|---|---|---|---|---|
| Layer | 39, 51 | 40, 52 | 41, 53 | 42, 54 |
| 1 | FPF | FPF | Glass 1 | FPF |
| 2 | Ionomer 4 | EVA 3 | EVA 1 | ACR 3 |
| 3 | P-PET 7 | P-PET 8 | P-PET 1 | P-PET 8 |
| 4 | Ionomer 4 | EVA 3 | EVA 1 | Ionomer 6 |
| 5 | Solar Cell 1 | Solar Cell 4 | Solar Cell 1 | Solar Cell 4 |
| 6 | Ionomer 4 | EVA 3 | EVA 1 | Ionomer 6 |
| 7 | P-PET 6 | P-PET 5 | P-PET 3 | P-PET 4 |

TABLE 4
Solar Cell Laminate Structures

| | Example | | | |
|---|---|---|---|---|
| Layer | 43, 55 | 44, 56 | 45, 57 | 46, 58 |
| 1 | Glass 1 | FPF | FPF | FPF |
| 2 | EVA 2 | Ionomer 5 | EVA 3 | ACR 3 |
| 3 | P-PET 1 | P-PET 7 | P-PET 8 | P-PET 7 |
| 4 | EVA 2 | Ionomer 5 | EVA 3 | Ionomer 4 |
| 5 | Solar Cell 1 | Solar Cell 4 | Solar Cell 4 | Solar Cell 1 |
| 6 | EVA 2 | Ionomer 5 | EVA 3 | Ionomer 4 |
| 7 | P-PET 1 | P-PET 2 | P-PET 8 | P-PET 7 |
| 8 | EVA 2 | Ionomer 5 | EVA 3 | ACR 3 |
| 9 | AL | AL | FPF | FPF |

### Examples 47-58

The 12-inch by 12-inch solar cell laminate structures described above in Tables 2-4 are assembled and laminated by Lamination Process 2. In Examples 47-54, Layer 1 constitutes the incident layer, Layers 2, 3, and 4 constitute the front-sheet encapsulant layer, Layer 6 constitutes the back-sheet encapsulant layer, and Layer 7 constitutes the back-sheet. In Examples 55-58, Layer 1 constitutes the incident layer, Layers 2, 3, and 4 constitute the front-sheet encapsulant layer, Layer 6, 7, and 8 constitute the back-sheet encapsulant layer, and Layer 9 constitutes the back-sheet.

What is claimed is:

1. A solar cell module comprising, from top to bottom:
(i) an incident layer, which is adjacent and laminated to,
(ii) a front-sheet encapsulant layer, which is adjacent and laminated to,
(iii) a solar cell layer comprising one or a plurality of electronically interconnected solar cells, which is adjacent and laminated to,
(iv) an optional back-sheet encapsulant layer, which is adjacent and laminated to,
(v) a back-sheet,
wherein at least one of said incident layer, front-sheet encapsulant layer, back-sheet encapsulant layer, and back-sheet comprises one layer of a polyester film having at least one surface coated with a coating of polyolefin having at least one primary amine functional group.

2. The solar cell module of claim 1, wherein said polyolefin having at least one primary amine functional group is selected from the group consisting of poly(allyl amine), poly(vinyl amine), and a combination thereof.

3. The solar cell module of claim 1, wherein said polyester film is a bi-axially-oriented poly(ethylene terephthalate) film.

4. The solar cell module of claim 1, wherein said incident layer comprises a first layer of said polyester film which has its inner surface coated with said coating of polyolefin having at least one primary amine functional group and adhered to said front-sheet encapsulant layer.

5. The solar cell module of claim 4, wherein a light-receiving outer surface of said first layer of polyester film is further coated with a coating material selected from the group consisting of barrier coatings, antireflective coatings and abrasion-resistance coatings.

6. The solar cell module of claim 4, wherein said back-sheet further comprises a second layer of said polyester film which has its inner surface coated with said coating of polyolefin having at least one primary amine functional group and adhered to said optional back-sheet encapsulant layer, or to a rear non-light-receiving surface of said solar cell layer when said optional second encapsulant layer is absent.

7. The solar cell module of claim 6, wherein a rear outer surface of said second layer of polyester film is further coated with a coating material selected from the group consisting of barrier coatings, abrasion-resistance coatings, and metal coatings.

8. The solar cell module of claim 1, wherein said back-sheet comprises one layer of said polyester film which has its inner surface coated with said coating of polyolefin having at least one primary amine functional group and adhered to said back-sheet encapsulant layer, or to a rear non-light-receiving surface of said solar cell layer when said optional second encapsulant layer is absent.

9. The solar cell module of claim 8, wherein a rear outer surface of said polyester film is further coated with a coating material selected from the group consisting of barrier coatings, abrasion-resistance coatings, and metal coatings.

10. The solar cell module of claim 1, wherein said front-sheet encapsulant layer comprises a first layer of said polyester film laminated between two polymeric films or sheets.

11. The solar cell module of claim 10, wherein said first layer of polyester film has both surfaces coated with said coating of polyolefin having at least one primary amine functional group.

12. The solar cell module of claim 10, wherein said first layer of polyester film is further coated with a barrier coating on one or both surfaces.

13. The solar cell module of claim 10, wherein said back-sheet encapsulant layer further comprises a second layer of said polyester film laminated between two polymeric films or sheets.

14. The solar cell module of claim 13, wherein said second layer of polyester film has both surfaces coated with said coating of polyolefin having at least one primary amine functional group.

15. The solar cell module of claim 14, wherein said second layer of polyester film is further coated with a barrier coating on one or both surfaces.

16. The solar cell module of claim 10, wherein said back-sheet further comprises a second layer of said polyester film which has its inner surface coated with said coating of polyolefin having at least one primary amine functional group and adhered to said optional back-sheet encapsulant layer, or to a rear non-light-receiving surface of said solar cell layer when said optional second encapsulant layer is absent.

17. The solar cell module of claim 16, wherein a rear outer surface of said second layer of polyester film is further coated with a coating material selected from the group consisting of barrier coatings, abrasion-resistance coatings, and metal coatings.

18. The solar cell module of claim 1, wherein said back-sheet encapsulant layer comprises one layer of said polyester film laminated between two polymeric films or sheets.

19. The solar cell module of claim 18, wherein said one layer of polyester film has both surfaces coated with said coating of polyolefin having at least one primary amine functional group.

20. The solar cell module of claim 19, wherein said one layer of polyester film is further coated with a barrier or metal coating on one or both surfaces.

21. A process for preparing a solar cell module comprising:
(i) providing an assembly comprising, from top to bottom: (a) an incident layer, which is adjacent and laminated to, (b) a front-sheet encapsulant layer, which is adjacent and laminated to, (c) a solar cell layer comprising one or a plurality of electronically interconnected solar cells, which is adjacent and laminated to, (d) an optional back-sheet encapsulant layer, which is adjacent and laminated to, (e) a back-sheet, wherein at least one of said incident layer, front-sheet encapsulant layer, back-sheet encapsulant layer, and back-sheet comprises one layer of a polyester film having at least one surface coated with a coating of polyolefin having at least one primary amine functional group; and
(ii) laminating the assembly to form the solar cell module.

22. The process of claim 21, wherein the step (ii) of lamination is conducted by subjecting the assembly to heat.

23. The process of claim 22, wherein the step (ii) of lamination further comprising subjecting the assembly to pressure.

24. The process of claim 22, wherein the step (ii) of lamination further comprising subjecting the assembly to vacuum.
